(19) United States
(12) Patent Application Publication
(10) Pub. No.: US 2010/0044996 A1
(43) Pub. Date: Feb. 25, 2010

(54) MOTORCYCLE FRONT TRANSMISSION DEVICE STRUCTURE

(76) Inventor: Michel Marqueton, Guangdong (CN)

Correspondence Address: SCIHEAD INTELLECTUAL PROPERTY LAW GROUP, LTD, Huihua Commercial & Trade Building, Suite 1508, 80 Xian Lie Zhong Road, Guangzhou, 51070, CN

(21) Appl. No.: 12/447,258

(22) PCT Filed: Oct. 30, 2007
(86) PCT No.: PCT/CN2007/003079

§ 371 Date: Apr. 27, 2009

(30) Foreign Application Priority Data
Oct. 30, 2006 (CN) 200610123045.3

(51) Int. Cl. B62K 21/18; F16C 35/12

(52) U.S. Cl. 280/276; 384/589

(57) ABSTRACT

The present invention discloses a motorcycle front transmission device structure, which consists of an operating arm, a suspending arm, a support frame, a connecting rod etc. This motorcycle front transmission device connects the front wheel, the handlebar and the body shell together by hinge joint. During driving, the force imposed on the front wheel can be transmitted to the body shell by the suspending arm, the upper connecting block and the damping spring so as to have a reasonable stress distribution. At the same time, the swing angle of the front wheel can be bigger and the control can be easier. The device can also reduce the motorcycle weight and lower production cost.

### FIELD OF THE INVENTION

The present invention relates to a motorcycle, especially a motorcycle front transmission device structure.

### BACKGROUND OF THE INVENTION

Motorcycle front transmission system providing connection between motorcycle front wheel and its body shell ensures the contact between motorcycle body and ground, and thereby ensures the contact between motorcycle wheel and ground. The tyre must maintain three-dimensional movement free:
1. Alternate revolution around motorcycle bearing drives the motorcycle to move forward, and this revolution can be liberated or be governed (when braking or drive wheel not being started);
2. Vertical translation make suspending device of the motorcycle possible, and thereby ensures users own complete facility and insurance. This kind of stability is controlled by the suspending device of the motorcycle (spring and damper); while control of suspending device alters speed, the geometry theory existing in the transmission device defines the journey under the wheel.
3. Alternate revolution around bearing of motorcycle steering system realizes diving of the motorcycle by the driver, and the motorcycle driver controls movement of the motorcycle by watching and controlling driving room; while movement of wheel is controlled through handle bar of the motorcycle, and control of the handle bar is achieved through the geometry theory existing in the transmission device.

Usually, bushing frame fork of the motorcycle achieves the functions listed above. The frame fork is mounted on the area around steering system post, which makes the motorcycle can be drive by the driver. Coat of guiding device and the frame fork make the suspending device produce lengthways shake.

Although use of the usual frame fork is very wide, the defect of itself restricts our thinking, and its merger effect on the steering system and the suspending device makes adjusting of the system harder. It is easy to find that plenty of parameters are interrelatedness.

The following geometry parameters affect related movement of the motorcycle: wheelbase, angle of frame, frame or head-on force of airflow, and angle and space between components.

Through principle of mechanics, the wheelbase, angle of frame and the head-on force of airflow will alter during the period that the suspending device is inserted into its place. So, movement of the motorcycle will not identical to the movement after the suspending device dropping or boosting pressure, which makes geometric mistake of the bushing frame fork much notable.

On the other side, all forces imposed on the tyre will be transmitted onto a position of the steering system post; the frame of this position will be strengthened greatly; a certain weight will be achieved on an area which is much higher than and far away from centre of gravity thereof, thereby the easy-controllability will be decreased greatly. Bushing frame fork also has a spiral fluctuation trend, especially when braking force is asymmetric (when having only a brake disk), a mistake of precision on the handle bar and an effect which would mentally result in personal risk will be raised.

### SUMMARY OF THE INVENTION

To solve the problem of prior art mentioned above, the present invention provides a new motorcycle front transmission device without bushing frame fork; the motorcycle front transmission device connects the handle bar, front wheel and body shell by hinge joint, which makes the swing angle of the front wheel bigger and stress distribution on the whole cycle even.

The present invention discloses the following technical solution:

A motorcycle front transmission device, comprising a front wheel, a wheel bearing and a handle bar, wherein it also comprises an operating arm, a suspending arm, an upper connecting block, a support frame and a connecting rod;

the front end of said suspending arm being hinge jointed with the lower end of said operating arm, the back end of said suspending arm being hinge jointed with body shell or engine;

the lower end of said operating arm being connected with said front wheel via wheel bearing;

one side of the upper end of said operating arm being hinge jointed with said handle bar, the other side of which being hinge jointed with said upper connecting block;

said support frame being respectively hinge jointed with said upper connecting block, said handle bar and said body shell or engine.

Further, said suspending arm has a shape as word “v”, being horizontally and symmetrically fixed on both sides of said body shell.

Further, the front end of said suspending arm is hinge jointed with the lower end of said operating arm via spherical coupling, the front end of said suspending arm being connected with both sides of said spherical coupling, and the back end of said suspending arm being hinge jointed with body shell or engine via bearing.

Further, said wheel bearing comprises inner ring and outer ring, the inner ring of said wheel bearing being fixed jointed with the lower end of said operating arm, the outer ring of said wheel bearing being fixed jointed with the wheel rim of said front wheel.

Further, a horizontal axle hole is mounted on the inner ring of said wheel bearing; said spherical coupling being mounted in said horizontal axle hole via axis pin which is vertical to ground.

Further, an axle hole is mounted on the inner ring of said wheel bearing, a double radial knuckle bearing being fixed in said axle hole, said suspending arm being hinge jointed with said operating arm via said double radial knuckle bearing.

Further, said double radial knuckle bearing comprises inner ring and outer ring, the inner ring and outer ring of said double radial knuckle bearing rotating freely and independently.

Further, said upper connecting block is hinge jointed with said operating arm via a pair of bearings which are vertical to each other.

Further, said upper connecting block is hinge jointed with said support frame via two horizontal ball bearings whose central axes are coincident.

And further, said handle bar is hinge jointed with said support frame via bearing, said bearing comprising inner ring and outer ring which are supported by two teams of ball bearing arranged up and down, the inner ring of said bearing being fixed jointed with said handle bar, and the outer ring of said bearing being fixed jointed with said support frame.

The motorcycle front transmission device of the present invention connects front wheel, handle bar and body shell together by hinge joint. The force imposed on the front wheel during driving can be transmitted onto the body shell through suspending arm, upper connecting block and damping spring, which makes the stress distribution on the whole cycle even. Moreover, for leading turning of the front wheel by the operating arm and suspending arm, the motorcycle front transmission device of the present invention overcomes the swing angle restriction of the front wheel brought by the front fork device of prior art, that is to say, the present invention can make the motorcycle turn around in a big angle scale.

The invention will be described below in more detail with reference to the accompanying drawings.

### BRIEF DESCRIPTION OF THE DRAWINGS

FIG. 1 shows a structure sketch map of a motorcycle with the motorcycle front transmission device of the present invention;

FIG. 2 shows a structure sketch map of the joint of the operating arm and the suspending arm in the first embodiment of the present invention;

FIG. 3 shows a sectional view of the joint of the operating arm and the suspending arm in the first embodiment of the present invention;

FIG. 4 shows a sectional view of the joint of the operating arm and the upper connecting block in the first embodiment of the present invention;

FIG. 5 shows a structure sketch map of the support frame and the upper connecting block in the first embodiment of the present invention;

FIG. 6 shows a sectional view of the joint of the support frame and the upper connecting block in the first embodiment of the present invention;

FIG. 7 shows a structure sketch map of the support frame and the handle bar in the first embodiment of the present invention;

FIG. 8 shows a sectional view of the joint of the support frame and the handle bar in the first embodiment of the present invention;

FIG. 9 shows a structure sketch map of the handle bar and connecting rod in the first embodiment of the present invention;

FIG. 10 shows a side elevation of the operating arm of the second embodiment of the present invention;

FIG. 11a-11c shows a structure sketch map of the double radial knuckle bearing in the third embodiment of the present invention;

FIG. 12 shows a structure sketch map of the operating arm and the inner ring of the wheel bearing in the third embodiment of the present invention.

### DETAILED DESCRIPTION OF PREFERRED EMBODIMENTS

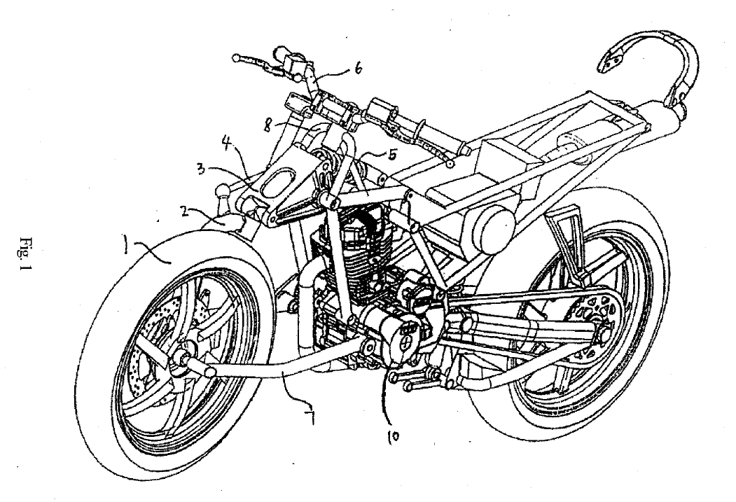

FIG. 1 shows a structure sketch map of the motorcycle with the motorcycle front transmission device of the present invention. This motorcycle comprises the motorcycle front transmission device and motorcycle body shell 10. Wherein the motorcycle front transmission device of the present invention comprises front wheel 1, operating arm 2, upper connecting block 3, connecting rod 4, damping spring 5, handle bar 6, suspending arm 7 and support frame 8.

Said suspending arm 7 is narrow in front and wide in behind with a shape as word “V”, which is horizontally and symmetrically fixed on both sides of said body shell 10. The front end of said suspending arm 7 is hinge jointed with the lower end of said operating arm 2, the back end of which is hinge jointed with said body shell 10. The lower end of said operating arm 2 is connected with said front wheel 1 via wheel bearing 12. One side of the upper end of said operating arm 2 is hinge jointed with said handle bar 6 via said connecting rod 4, the other side of which is hinge jointed with said upper connecting block 3. Said handle bar 6 is hinge jointed with said support frame 8, and with a damping spring 5 connected between. Said support frame 8 is also hinge jointed with said upper connecting block 3 and said body shell 10 respectively.

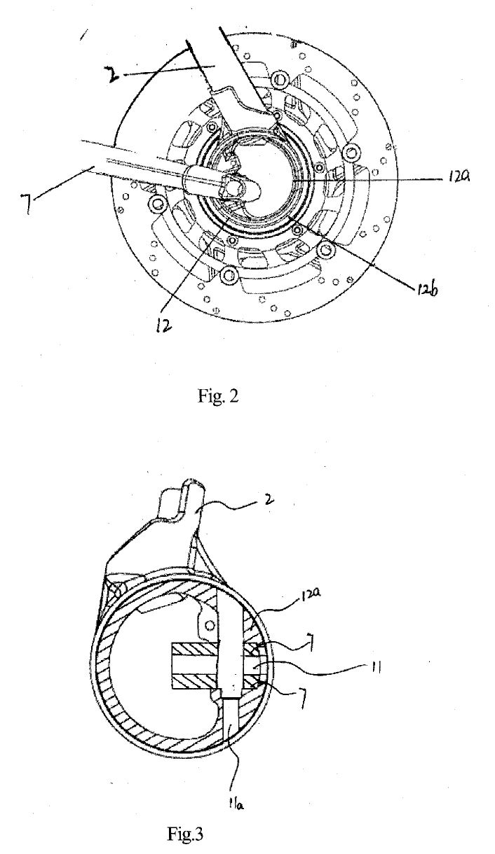

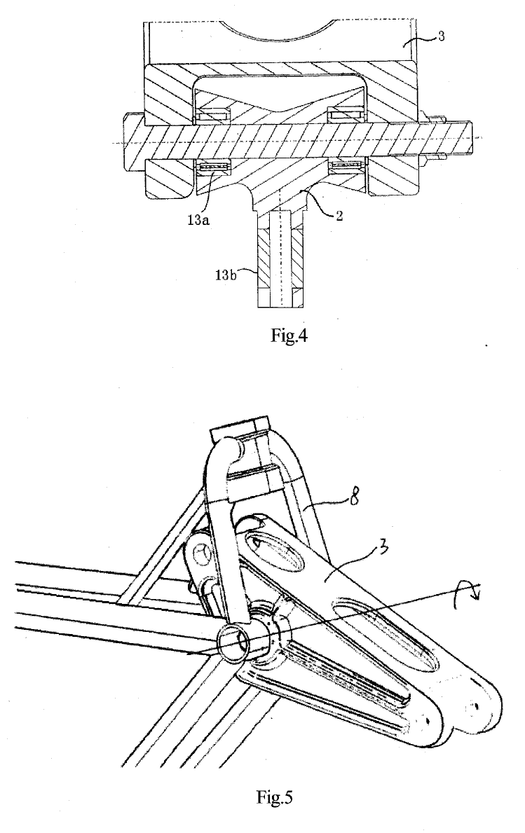

As shown in FIG. 2 and FIG. 3, said wheel bearing 12 comprises inner ring 12a and outer ring 12b, said inner ring 12a is fixed connected with the lower end of said operating arm 2, said outer ring 12b is fixed in the middle of the wheel rim of said front wheel 1, in order to achieve connection between said operating arm 2 and said front wheel 1. Said inner ring 12a still comprises a horizontal axle hole, a spherical coupling 11 is mounted in this horizontal axle hole. The front end of said suspending arm 7 is respectively connected with the up and down sides of said spherical coupling 11. Said spherical coupling 11 is fixed in the horizontal axle hole via the axis pin 11a which is vertical to ground.

Said operating arm 2 is hinge jointed with said upper connecting block 3 via bearings 13a and 13b, and said bearing 13a and bearing 13b are vertical to each other, so that said operating arm 2 and said upper connecting block 3 can move relative to each other in any direction.

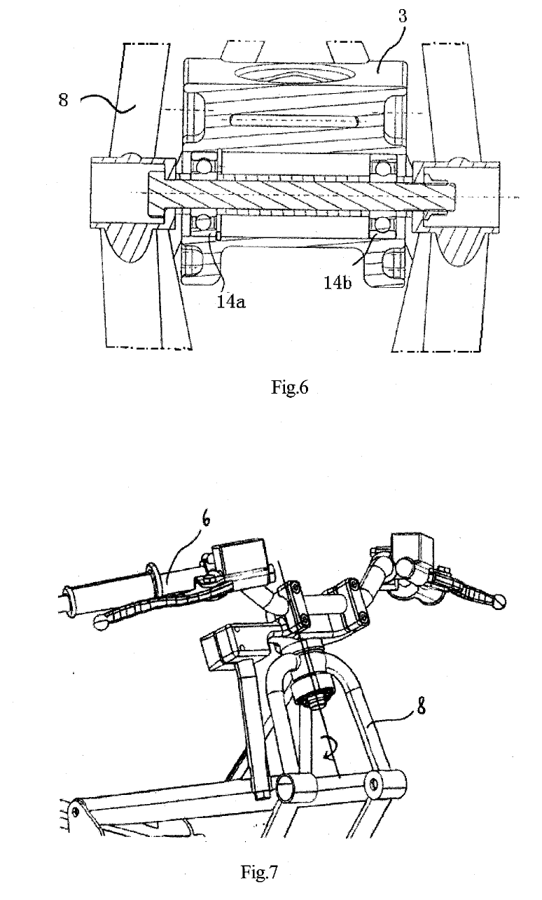

As shown in FIG. 5 and FIG. 6, said upper connecting block 3 is triangular, and in the middle of which two teams of ball bearings 14a and 14b are mounted, and the central axes of said ball bearings 14a and 14b are coincident and horizontal. The inner rings of said ball bearings 14a and 14b are fixed connected with said support frame 8, and the outer rings of said ball bearings 14a and 14b are fixed connected with said upper connecting block 3.

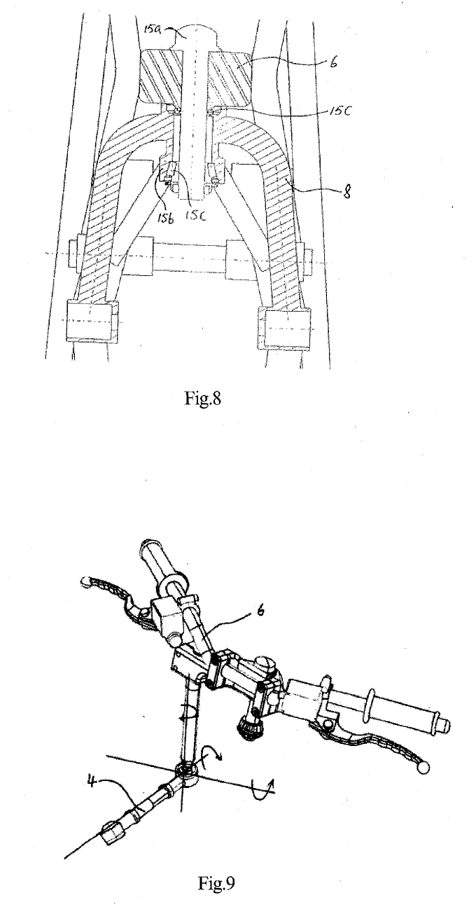

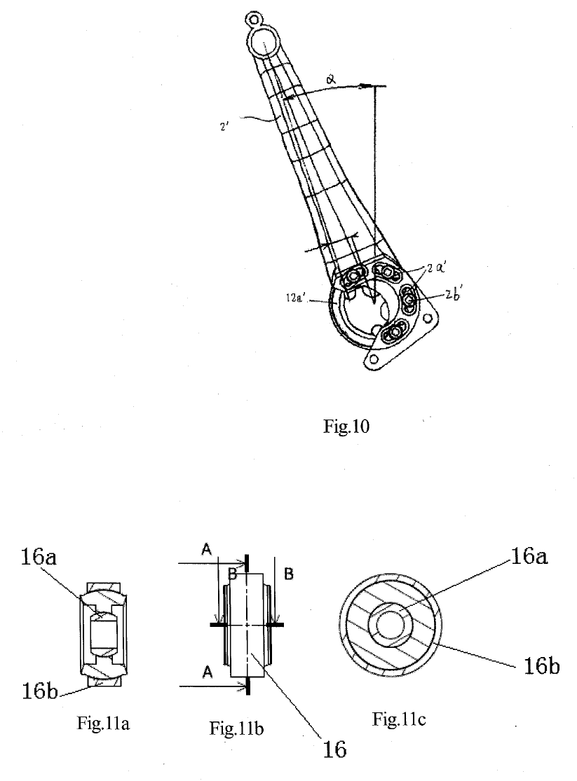

As shown in FIG. 7 and FIG. 8, said handle bar 6 is hinge jointed with said support frame 8 via bearing 15. Said handle bar 6 is fixed connected with the inner ring 15a of said bearing 15, and said support frame 8 is fixed connected with the outer ring 15b of said bearing 15. The inner ring 15a and the outer ring 15b are supported by two teams of balls 15c arranged up and down.

As shown in FIG. 9, a spherical hinge is mounted on each end of said connecting rod 4; one end thereof is connected with said handle bar 6, and the other end is connected with a side of the upper end of said operating arm 2.

In the second embodiment of the present invention, the back end of the suspending arm is hinge jointed with the engine of the motorcycle, and the support frame is also hinge jointed with the engine of the motorcycle. A plurality of corresponding long holes 2a′ may be mounted on the lower end of the operating arm 2′ and the inner ring 12 a′ of the wheel bearing; and a bolt 2b′ drills through corresponding said long holes 2a′, in order to fix the lower end of said operating arm 2′ and the inner ring 12a′ of said wheel bearing. So the angle between said operating arm 2′ and ground can be adjusted according to demands.

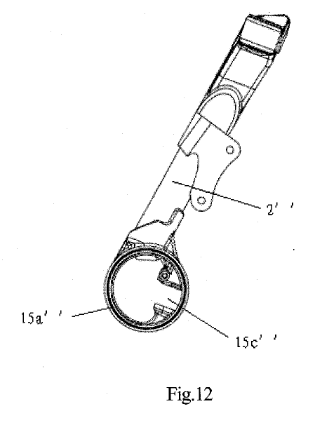

As shown in FIG. 12, in the third embodiment of the present invention, an axle hole 15c″ is mounted on the operating arm 2″ and the inner ring 15a″ of the wheel bearing. A double radial knuckle bearing 16 is fixed in said axle hole 15c″, said suspending arm being hinge jointed with said operating arm 2″ via said double radial knuckle bearing 16. As shown in FIG. 11, said double radial knuckle bearing 16 further comprises inner ring 16a and outer ring 16b, the inner ring 16a and the outer ring 16b of said double radial knuckle bearing can respectively rotate freely and independently.

The inner ring 16a of said double radial knuckle bearing 16 can rotate freely, and at the same time the outer ring 16b thereof can rotate independently too. So during driving of the motorcycle mounted with the motorcycle front transmission device of the present invention, front wheel 1 can rotate more freely and its swing angle can be bigger.

During driving process of the motorcycle mounted with the motorcycle front transmission device of the present invention, the force imposed on said front wheel 1 can be respectively transmit to the body shell of the motorcycle through said suspending arm 7, said upper connecting block 3 and said damping spring 5, which makes the force distribution imposed on the motorcycle body even. Said suspending arm 7 distributed symmetrically on both sides of the motorcycle body bears force symmetrically during driving of the motorcycle, which make the motorcycle body have better balance. The cross section of suspending arm 7 can be designed smaller according to demands, so as to decrease weight of the motorcycle body and reduce production cost.

Said suspending arm 7 is hinge jointed with said operating arm 2, and said spherical coupling 11 is mounted horizontally in the axle hole via axis pin which is vertical to ground. In this way, said operating arm 2 will not be imposed of exterior restriction on left and right when controlling front wheel 1, and the swing angle of said front wheel 1 can be bigger and the control can be easier Fine rigidity can still be maintained according to the present invention when strong twist distortion occurs.

The angle between said operating arm 2′ and ground can be adjusted according to demands according to the present invention, so the basic geometric parameter of the motorcycle body can be altered without changing any components.

What disclosed above is only the preferred embodiment of the present invention, which of course can not be interpreted to confine the claim scope of the present invention, so equable change based on the disclosure of the patent application of the present invention is also in the claim scope of the present invention.

What is claimed is:

1. A motorcycle front transmission device, comprising a front wheel, a wheel bearing and a handle bar, wherein said motorcycle front transmission device also comprises an operating arm, a suspending arm, an upper connecting block, a support frame and a connecting rod;
the front end of said suspending arm being hinge jointed with the lower end of said operating arm, the back end of said suspending arm being hinge jointed with body shell or engine;
the lower end of said operating arm being connected with said front wheel via wheel bearing;
one side of the upper end of said operating arm being hinge jointed with said handle bar, the other side of which being hinge jointed with said upper connecting block;
said support frame being respectively hinge jointed with said upper connecting block, said handle bar and said body shell or engine.

2. The motorcycle front transmission device of claim 1, wherein said suspending arm has a “v” shape, being horizontally and symmetrically fixed on both sides of said body shell.

3. The motorcycle front transmission device of claim 1, wherein the front end of said suspending arm is hinge jointed with the lower end of said operating arm via spherical coupling, the front end of said suspending arm being connected with both sides of said spherical coupling, and the back end of said suspending arm being hinge jointed with body shell or engine via bearing.

4. The motorcycle front transmission device of claim 1, wherein said wheel bearing comprises inner ring and outer ring, the inner ring of said wheel bearing being fixed jointed with the lower end of said operating arm, the outer ring of said wheel bearing being fixed jointed with the wheel rim of said front wheel.

5. The motorcycle front transmission device of claim 4, wherein a horizontal axle hole is mounted on the inner ring of said wheel bearing; said spherical coupling being mounted in said horizontal axle hole via axis pin which is vertical to ground.

6. The motorcycle front transmission device of claim 4, wherein an axle hole is mounted on the inner ring of said wheel bearing, a double radial knuckle bearing being fixed in said axle hole, said suspending arm being hinge jointed with said operating arm via said double radial knuckle bearing.

7. The motorcycle front transmission device of claim 6, wherein said double radial knuckle bearing comprises inner ring and outer ring, the inner ring and the outer ring of said double radial knuckle bearing rotating freely and independently.

8. The motorcycle front transmission device of claim 1, wherein said upper connecting block is hinge jointed with said operating arm via a pair of bearings which are vertical to each other.

9. The motorcycle front transmission device of claim 1, wherein said upper connecting block is hinge jointed with said support frame via two horizontal ball bearings whose central axes are coincident.

10. The motorcycle front transmission device of claim 1, wherein said handle bar is hinge jointed with said support frame via bearing, said bearing comprising inner ring and outer ring which are supported by two teams of ball bearing arranged up and down, the inner ring of said bearing being fixed jointed with said handle bar, and the outer ring of said bearing being fixed jointed with said support frame.
